(19) United States
(12) Patent Application Publication
(10) Pub. No.: US 2015/0077640 A1
(43) Pub. Date: Mar. 19, 2015

(54) DISPLAY DEVICE AND DISPLAY METHOD

(71) Applicant: Takashi Kanda, Osaka-shi (JP)

(72) Inventor: Takashi Kanda, Osaka-shi (JP)

(73) Assignee: SHARP KABUSHIKI KAISHA, Osaka-shi, Osaka (JP)

(21) Appl. No.: 14/382,056

(22) PCT Filed: Sep. 6, 2012
(86) PCT No.: PCT/JP2012/072738

§ 371 Date: Aug. 29, 2014

(30) Foreign Application Priority Data
Mar. 2, 2012 (JP) 2012-046333

(51) Int. Cl. H04N 9/31

(52) U.S. Cl. CPC H04N 9/3182
USPC 348/713

(57) ABSTRACT

To optimize combinations of values of four primary colors in a display device supporting four-primary-color display, with consideration given to display performances such as the power consumption in a light-emitting display device and the viewing angle characteristics in the non-light-emitting display device. The display device of the present invention displays video indicated by an input video signal using pixels composed of four primary colors and each having at least one sub-pixel for one primary color. When representing pixel colors of pixel signals in the input video signal, at least one pixel color which has a lightness less than a predetermined lightness determined depending on a color gamut representable by the display device and which is in areas except on a boundary of the color gamut is represented using only three primary colors among the four primary colors. For example, if the four primary colors are red, green, blue, and yellow, the pixel colors are represented using either a set of green, blue, and yellow, or a set of red, blue, and yellow depending on chromaticity indicated by the pixel signals.

### TECHNICAL FIELD

The present invention relates to a display device and, more particularly, to a display device supporting four-primary-color display.

### BACKGROUND OF THE INVENTION

As a method for extending a color reproduction range (color gamut) of a display device, there exists a method of increasing the number of primary colors. Since in general a pixel signal in a video signal input to the display device is a signal for representing three primary colors, a display device performing a display by use of four or more primary colors is provided with a color converter that converts the input pixel signal into a signal representative of four or more primary colors (see, e.g., Patent Document 1). Four primary colors can be e.g., a combination of R (red), G (green), B (blue), and Y (yellow), a combination of R, G, B, and W (white), or a combination of R, G, B, and C (cyan).

The color converter described in Patent Document 1 calculates a color conversion value corresponding to input white or a color conversion value for a predetermined point corresponding to white; based on the color conversion value corresponding to white, calculates an adjustment value so that the adjusted color conversion value corresponding to white lies inside of the color reproduction range; and, using the adjustment value, adjusts the color conversion value of input image data. Due to the white-corresponding color conversion value lying inside the color reproduction range, this color converter can suppress variations in the white color conversion results.

Patent Document 2 discloses a display device with support for multi primary colors, aiming at securing the luminance of videos containing high-saturation primary colors such as R, G, and B to improve the display quality.

### PRIOR ART DOCUMENT

### Patent Documents

Patent Document 1: Japanese Laid-Open Patent Publication No. 2007-134752
Patent Document 2: Japanese Laid-Open Patent Publication No. 2011-164464

### SUMMARY OF THE INVENTION

### Problem to be Solved by the Invention

By the way, the combination of values of primary colors for representing (reproducing) one color is uniquely determined in the case of a display device capable of only three primary colors, whereas in the case of a display device supporting multi primary colors such as four primary colors there exist a plurality of combinations so that a combination is not uniquely determined.

In the conventional display devices supporting four-primary-color display inclusive of the techniques described in Patent Documents 1 and 2, however, optimization is not performed of which combination is to be used among combinations of values of four primary colors for representing one color.

For example, the technique described in Patent Document 1 focuses on the precision in reproduction of video from input video signals and on the simplicity of conversion; more specifically, aims merely at converting tristimulus values X, Y, and Z that are input image data into values of four primary colors such that they are precisely reproduced on a display panel; and therefore is not a technique giving consideration to the combinations of values of four primary colors. The technique described in Patent Document 2 controls the luminance of a backlight light source to be high for frames or blocks in a non-light-emitting display device if primary color pixels having a certain level of or higher saturation are contained, and therefore is not a technique giving consideration to the pixel value processing, not to mention combinations of values of four primary colors.

In this manner, the conventional display device supporting four-primary-color display does not optimize combinations of values of primary colors for representing one color. However, if the optimization is performed with the aim of a reduction in the power consumption or of an improvement in the viewing angle characteristics, it will be extremely beneficial and hence it is desirable to perform such an improvement.

The present invention was conceived in view of the above circumstances and an object thereof is to optimize combinations of values of four primary colors in a display device supporting four-primary-color display, with consideration given to display performances such as the power consumption in a light-emitting display device and the viewing angle characteristics in the non-light-emitting display device.

### Means for Solving the Problem

To solve the above problems, a first technical means of the present invention is a display device displaying video indicated by an input video signal using pixels composed of four primary colors and each having at least one sub-pixel for one primary color, wherein when representing pixel colors of pixel signals in the input video signal, at least one pixel color which has a lightness less than a predetermined lightness determined depending on a color gamut representable by the display device and which is in areas except on a boundary of the color gamut is represented using only three primary colors among the four primary colors.

A second technical means is the display device of the first technical means, wherein the display device is a device performing a display based on gradation data in which a display luminance becomes lower as a gradation value decreases, and the display device comprises: a color conversion processing portion that converts components of the pixel signals in the input video signal into combinations of gradation values minimizing a sum of the gradation values for output to sub-pixels corresponding respectively to the four primary colors.

A third technical means is the display device of the first technical means, wherein the display device is a device performing a display based on gradation data in which a display luminance becomes higher as a gradation value decreases, and the display device comprises: a color conversion processing portion that converts components of the pixel signals in the input video signal into combinations of gradation values maximizing a sum of the gradation values for output to sub-pixels corresponding respectively to the four primary colors.

A fourth technical means is the display device of the second or the third technical means, wherein the color conversion processing portion has a three-dimensional look-up table for converting the components of the pixel signals in the input video signal into gradation values for output to sub-pixels corresponding respectively to the four primary colors.

A fifth technical means is the display device of any one of the second to the fourth technical means, wherein any one of RGB signals, tristimulus value XYZ signals, and signals of four colors including RGB are input as the pixel signals in the input video signal into the color conversion processing portion.

A sixth technical means is the display device of any one of the first to the fifth technical means, wherein the four primary colors are red, green, blue, and yellow, and wherein either a set of red, yellow, and blue or a set of green, yellow, and blue is used as the three primary colors depending on chromaticity indicated by the pixel signals in the input video signal.

A seventh technical means is the display device of any one of the first to the fifth technical means, wherein the four primary colors are red, green, blue, and white, and wherein a set of red, green, and white or a set of green, blue, and white or a set of blue, red, and white is used as the three primary colors depending on chromaticity indicated by the pixel signals in the input video signal.

An eighth technical means is the display device of any one of the first to the fifth technical means, wherein the four primary colors are red, green, blue, and cyan, and wherein either a set of green, cyan, and red or a set of blue, cyan, and red is used as the three primary colors depending on chromaticity indicated by the pixel signals in the input video signal.

A ninth technical means is the display device of any one of the first to the eighth technical means, comprising: a non-light-emitting display panel; and a backlight irradiating a back of the display panel, wherein video indicated by the input video signal is displayed on the display panel.

A tenth technical means is the display device of any one of the first to the eighth technical means, comprising: a light-emitting display panel, wherein video indicated by the input video signal is displayed on the display panel.

An eleventh technical means is the display device of any one of the first to the eighth technical means, wherein the display device is a projection display device comprising: a non-light-emitting display panel displaying video indicated by the input video signal; a backlight irradiating a back of the display panel; a transmissive screen; and a projection lens projecting video displayed on the display panel onto a rear of the screen.

### Effect of the Invention

According to the display device supporting four-primary-color display of the present invention, combinations of values of four primary colors can be optimized with consideration given to display performances such as the power consumption in the light-emitting display device and the viewing angle characteristics in the non-light-emitting display device.

### BRIEF DESCRIPTION OF DRAWINGS

FIG. 1 is a block diagram of a configuration example of a liquid crystal display device according to an embodiment of the present invention.

FIG. 2 diagrammatically depicts a configuration example of a display portion in the liquid crystal display device of FIG. 1.

FIG. 3 depicts a configuration example of each sub-pixel forming portion in the display portion of FIG. 2.

FIG. 4 depicts an example of a color gamut representable by the liquid crystal display device.

FIG. 5 depicts an example of a region having a lightness not more than a predetermined lightness in the color gamut of FIG. 4.

FIG. 6 depicts another example of the region having a lightness not more than a predetermined lightness in the color gamut of FIG. 4.

FIG. 7 depicts an example of the lighting rate of each of primary colors at L*=20 in a liquid crystal display device supporting four-primary-color (RGBY) display according to the present invention.

FIG. 8 depicts an example of the lighting rate of each of primary colors at L*=20 in the conventional liquid crystal display device supporting three-primary color (RGB) display.

FIG. 9 depicts an example of the lighting rate of each of primary colors at L*=20 in a liquid crystal display device supporting four-primary-color (RGBW) display according to the present invention.

FIG. 10 depicts an example of the lighting rate of each of primary colors at L*=80 in the liquid crystal display device supporting four-primary-color (RGBY) display according to the present invention.

FIG. 11 depicts an example of the lighting rate of each of primary colors at L*=80 in the conventional liquid crystal display device supporting three-primary color (RGB) display.

FIG. 12 depicts an example of the lighting rate of each of primary colors at L*=80 in the liquid crystal display device supporting four-primary-color (RGBW) display according to the present invention.

### PREFERRED EMBODIMENT OF THE INVENTION

A display device of the present invention is a device displaying video that an input video signal indicates by pixels composed of four primary colors. The pixel has at least one sub-pixel for one primary color. That is, one pixel in this display device has one or more sub-pixels for one primary color and, for example, as depicted in a configuration example below, a single sub-pixel may be provided for each primary color to make up one pixel. Alternatively, two sub-pixels may be provided for one primary color and one sub-pixel may be provided for the other primary colors, to make up one pixel. Although description is made on the assumption that the total aperture ratio of sub-pixels of each primary color is constant, a different aperture ratio may be employed for each primary color.

The display device of the present invention will now be described by way of example of a liquid crystal display device.

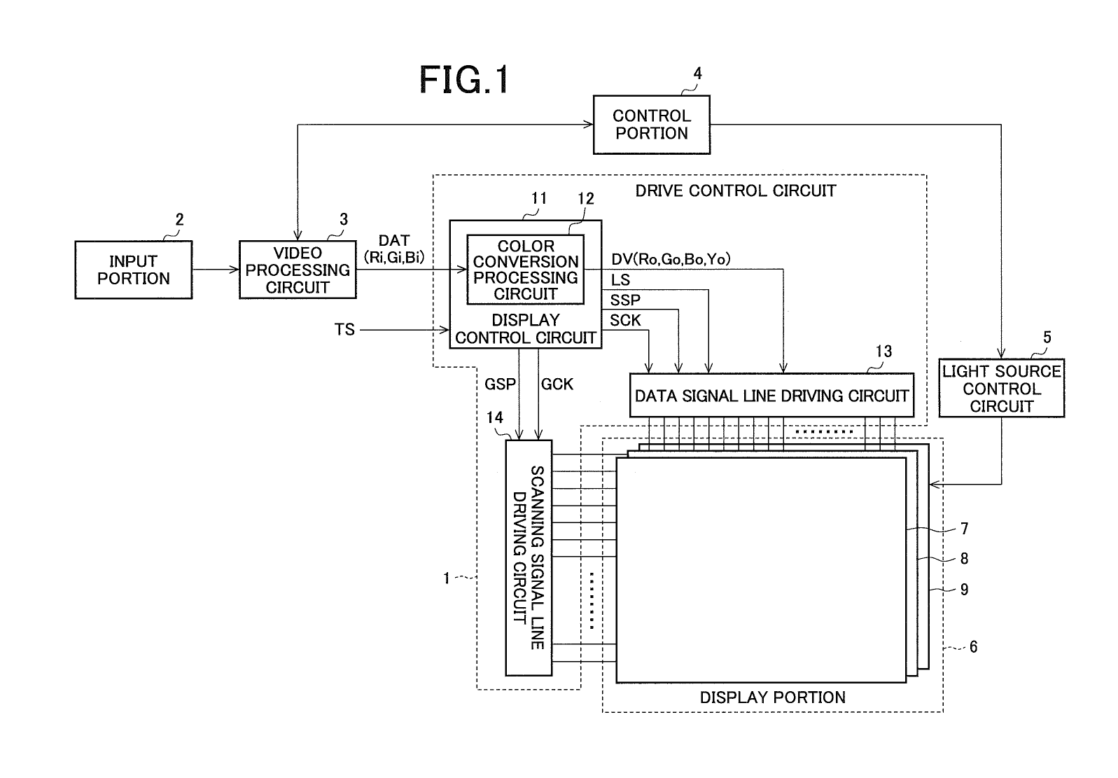

FIG. 1 is a block diagram of a configuration example of a liquid crystal display device according to an embodiment of the present invention. Although description in this configuration example is given by way of example of a liquid crystal display device employing RGBY (red, green, blue, and yellow) as the four primary colors, substantially the same basic configuration will apply to any liquid crystal display device with support for other four primary colors such as RGBW (red, green, blue, and white) and RGBC (red, green, blue, and cyan). The liquid crystal display device of this configuration example is configured roughly from a drive control circuit 1, an input portion 2, a video processing circuit 3, a control portion 4, a light source control circuit 5, and a display portion 6 having an active matrix type color liquid crystal panel supporting four primary colors. However, this configuration example is not limitative and any liquid crystal display device supporting four-primary-color display is available.

The drive control circuit 1 generates a drive signal for driving the display portion 6. The input portion 2 is an external interface inputting a video signal from an external device connecting thereto such as a tuner, a game machine, a player, or a recorder that receives a digital broadcast signal to input the video signal contained in the digital broadcast signal. This video signal input from the input portion 2 will hereinafter be referred to as input video signal. The video processing circuit 3 is a circuit that executes various signal processes in response to an input video signal from the input portion 2. The control portion 4 includes a CPU (Central Processing Unit) controlling the action of the liquid crystal display device; and a memory.

In compliance with a control command from the control portion 4, the light source control circuit 5 controls electric power supplied to a backlight light source 9 making up the display portion 6, to adjust the luminance of the backlight light source 9. For example, depending on the video feature quantity (e.g., average luminance level or maximum luminance level) of an RGB signal output from the video processing circuit 3, the light source control circuit 5 adjusts the luminance of the backlight light source 9 for each of divided regions obtained by dividing a screen.

The display portion 6 includes a color filter 7, a liquid crystal panel body 8, and the backlight light source 9. As depicted in FIG. 3 described later, the liquid crystal panel body 8 is formed with a plurality of data signal lines Ls and a plurality of scanning signal lines Lg intersecting the plurality of data signal lines Ls. This liquid crystal panel body 8 and the color filter 7 make up a color liquid crystal panel including a plurality of pixel forming portions arranged in matrix form. The backlight light source 9 may be for example an LED (Light Emitting Diode) or a CCFL (Cold Cathode Fluorescent Lamp).

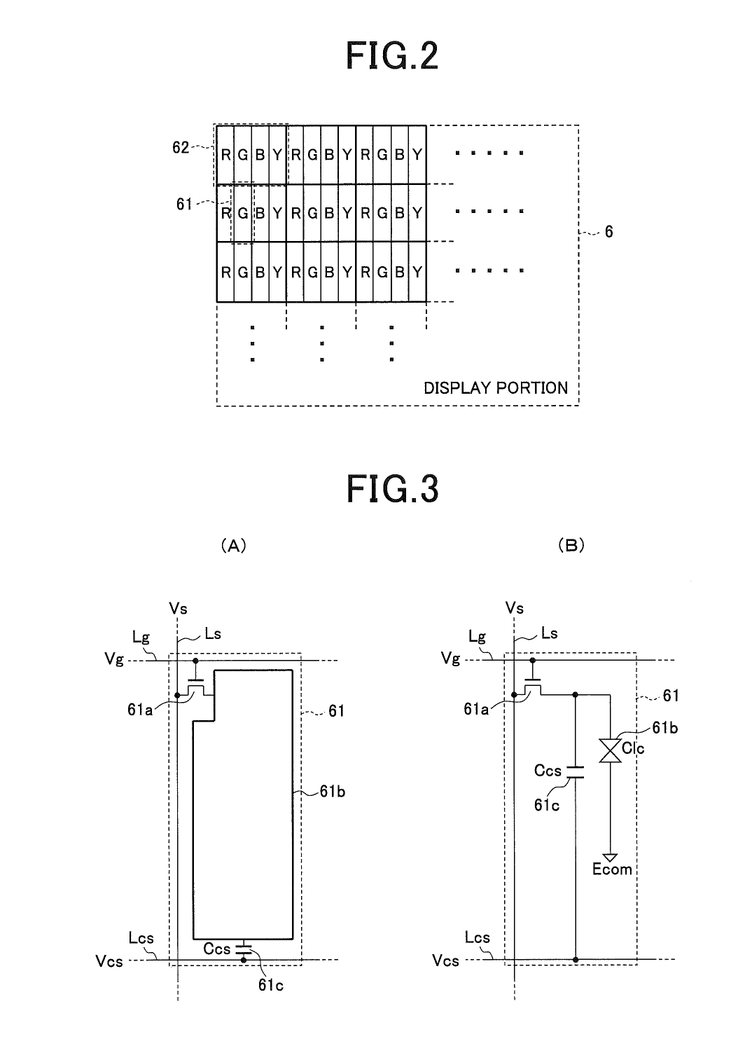

FIG. 2 diagrammatically depicts a configuration example of the display portion 6. Each of pixel forming portions 62 in the display portion 6 includes an R sub-pixel forming portion 61, a G sub-pixel forming portion 61, a B sub-pixel forming portion 61, and a Y sub-pixel forming portion 61 corresponding to red, green blue, and yellow, respectively. Pixels of a color image displayed by this display portion 6 are each composed of an R sub-pixel, a G sub-pixel, a B sub-pixel, and a Y sub-pixel corresponding to red, green, blue, and yellow, respectively.

FIG. 3 depicts a configuration example of each sub-pixel forming portion of FIG. 2. FIG. 3(A) is a diagram depicting an electrical configuration of one sub-pixel forming portion 61 in the display portion 6 (mainly the liquid crystal panel body 8 and the color filter 7), while FIG. 3(B) is an equivalent circuit diagram depicting an electrical configuration of the sub-pixel forming portion 61. As depicted in FIGS. 2 and 3, each pixel forming portion 62 in this configuration example includes the sub-pixel forming portions 61 that are equal in number to the number of primary colors for displaying a color image, with each sub-pixel forming portion 61 being disposed corresponding to intersections between the plurality of data signal lines Ls and the plurality of scanning signal lines Lg. Auxiliary capacitance lines Lcs are disposed extending in parallel to the scanning signal lines Lg and a common electrode Ecom is disposed that is common to all of the sub-pixel forming portions 61.

In FIG. 3, each sub-pixel forming portion 61 includes a TFT (Thin Film Transistor) 61a as a switching element having a gate terminal connected to the scanning signal line Lg extending through an intersection corresponding thereto and a source terminal connected to the data signal line Ls extending through the intersection; a pixel electrode 61b connected to a drain terminal of the TFT 61a; and an auxiliary electrode 61c disposed to form an auxiliary capacitance Ccs between the pixel electrode 61b and the auxiliary electrode 61c. Each sub-pixel forming portion 61 includes the common electrode Ecom common to all the sub-pixel forming portions 61; and a liquid crystal layer as an electrooptic element clamped between the pixel electrode 61b and the common electrode Ecom, with a liquid crystal capacitance Clc being formed by the pixel electrode 61b, the common electrode Ecom, and the liquid crystal layer clamped therebetween.

The drive control circuit 1 includes a display control circuit 11, a data signal line driving circuit 13, and a scanning signal line driving circuit 14. The display control circuit 11 receives data signals DAT (Ri, Gi, Bi) from the video processing circuit 3 and a timing control signal TS from a timing controller not shown and outputs digital video signals DV (Ro, Go, Bo, Yo), a data start pulse signal SSP, a data clock signal SCK, a latch strobe signal LS, a gate start pulse signal GSP, a gate clock signal GCK, etc. The signals such as SSP, SCK, LS, GSP, and GCK are timing signals for controlling the timing to display an image on the display portion 6.

As depicted in FIG. 2, each sub-pixel forming portion 61 of the display portion 6 includes an R sub-pixel forming portion, a G sub-pixel forming portion, a B sub-pixel forming portion, and a Y sub-pixel forming portion corresponding to red, green, blue, and yellow, respectively, and the data signal DAT includes three primary color signals (Ri, Gi, Bi) corresponding to three primary colors, red, green, and blue, respectively. Therefore, the display control circuit 11 is provided with a color conversion processing circuit 12 that converts input primary color signals (Ri, Gi, Bi) corresponding to three primary colors RGB into output primary color signals (Ro, Go, Bo, Yo) corresponding to four primary colors RGBY. The digital video signals DV are output primary color signals (Ro, Go, Bo, Yo) output from the color conversion processing circuit 12, to thereby display a color image to be displayed on the display portion 6.

The data signal line driving circuit 13 receives the digital image signals DV (Ro, Go, Bo, Yo), the data start pulse signal SSP, the data clock signal SCK, and the latch strobe signal LS output from the display control circuit 11 and applies a data signal voltage Vs as a drive signal to each data signal line Ls to charge the pixel capacitance (Clc+Ccs) in each sub-pixel forming portion 61 in the display portion 6. At that time, in the data signal line driving circuit 13, the digital video signals DV each indicative of a voltage to be applied to each data signal line Ls are retained in sequence at timing when a pulse of the data clock signal SCK occurs. Then, at timing when a pulse of the latch strobe signal LS occurs, the retained digital video signals DV are converted into analog voltages which are in turn applied concurrently as data signal voltages Vs to all the data signal lines Ls in the display portion 6.

The data signal line driving circuit 13 generates the data signal voltages Vs in the form of analog voltages corresponding to the primary color signals Ro, Go, Bo, and Yo making up the digital video signals DV; applies a data signal voltage Vs corresponding to the red primary color Ro to a data signal line Ls connected to the R sub-pixel forming portion 61; applies a data signal voltage Vs corresponding to the green primary color Go to a data signal line Ls connected to the G sub-pixel forming portion 61; applies a data signal voltage Vs corresponding to the blue primary color Bo to a data signal line Ls connected to the B sub-pixel forming portion 61; and applies a data signal voltage Vs corresponding to the yellow primary color Yo to a data signal line Ls connected to the Y sub-pixel forming portion 61.

The scanning signal line driving circuit 14 applies an active scanning signal (a scanning signal voltage Vg turning on the TFT 61a) in sequence to the scanning signal lines Lg in the display portion 6 based on the gate start pulse signal GSP and the gate clock signal GCK output from the display control circuit 11.

The drive control circuit 1 further includes an auxiliary electrode driving circuit and a common electrode driving circuit both not shown. A predetermined auxiliary electrode voltage Vcs is applied from the auxiliary electrode driving circuit to each of the auxiliary capacitance lines Lcs while a predetermined common voltage Vcom is applied from the common electrode driving circuit to the common electrode Ecom. The auxiliary electrode voltage Vcs and the common voltage Vcom may be the same voltage so that the auxiliary electrode driving circuit and common electrode driving circuit can be the same electrode driving circuit.

In the display portion 6, as described above, the data signal voltage Vs, the scanning signal voltage Vg, the common voltage Vcom, and the auxiliary electrode voltage Vcs are applied respectively to the data signal lines Ls, the scanning signal lines Lg, the common electrode Ecom, and the auxiliary capacitance lines Lcs. This allows voltages corresponding to the digital video signals DV to be kept in the pixel capacitance of each sub-pixel forming portion 61 to be applied to the liquid crystal layer, with the result that color images indicated by the digital video signals DV appear on the display portion 6.

At that time, each R sub-pixel forming portion 61 controls the transmission amount of red light in accordance with a voltage kept in the interior pixel capacitance thereof; each G sub-pixel forming portion 61 controls the transmission amount of green light in accordance with a voltage kept in the interior pixel capacitance thereof; each B sub-pixel forming portion 61 controls the transmission amount of blue light in accordance with a voltage kept in the interior pixel capacitance thereof; and each Y sub-pixel forming portion 61 controls the transmission amount of yellow light in accordance with a voltage kept in the interior pixel capacitance thereof.

As described above, the liquid crystal display device supporting four-primary-color display of the present invention is provided with a liquid crystal panel and a backlight that irradiates the back of the display panel so that a video indicated by an input video signal appears on the display panel.

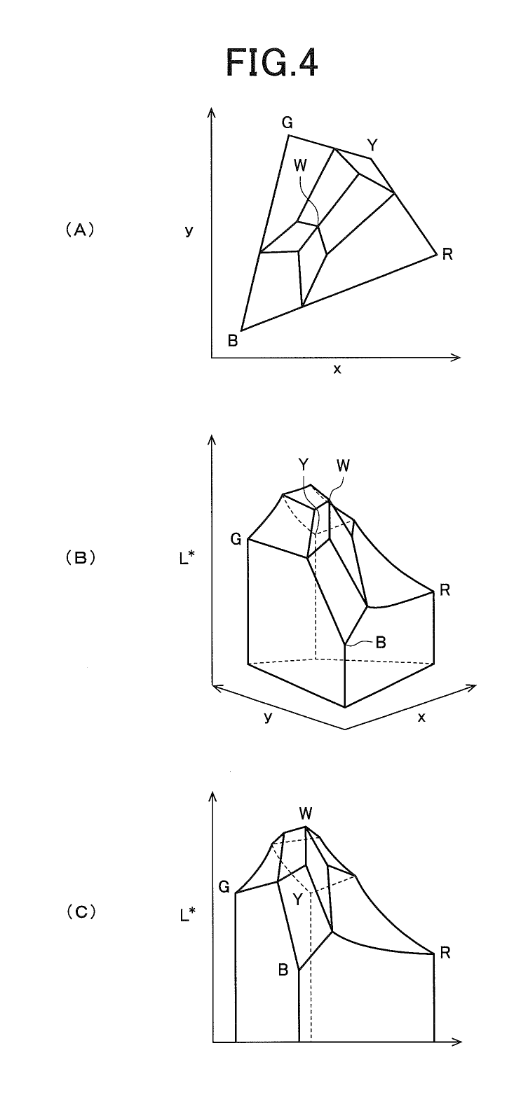

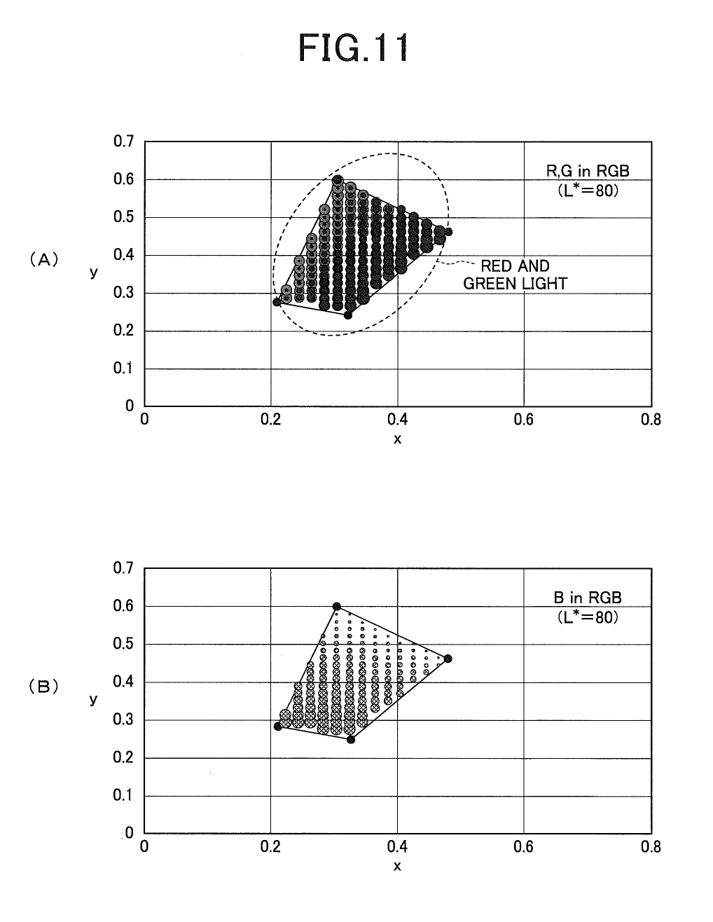

Referring to FIGS. 4 to 12, main features of the present invention will be described below.

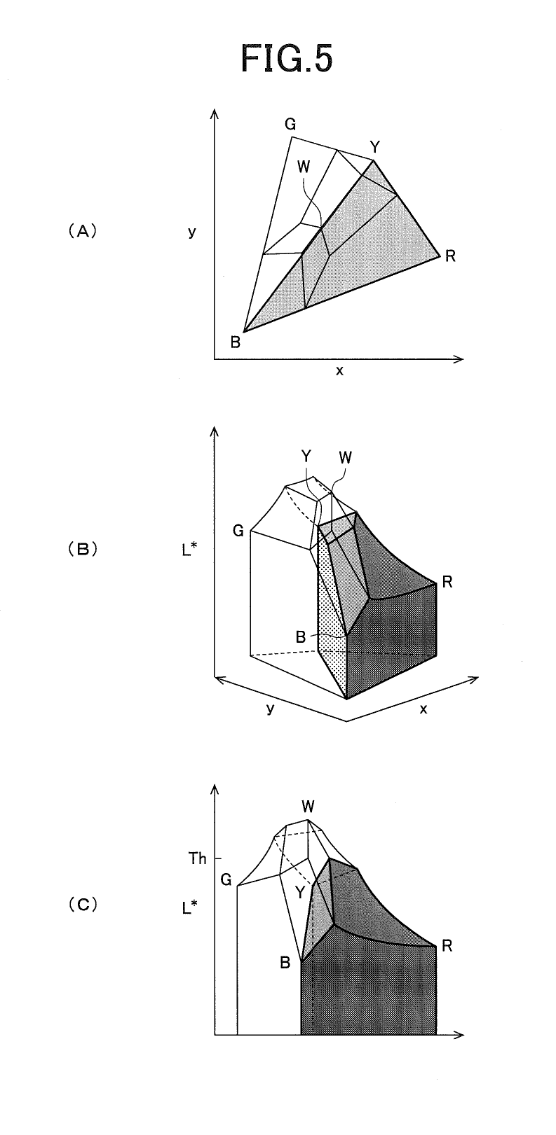

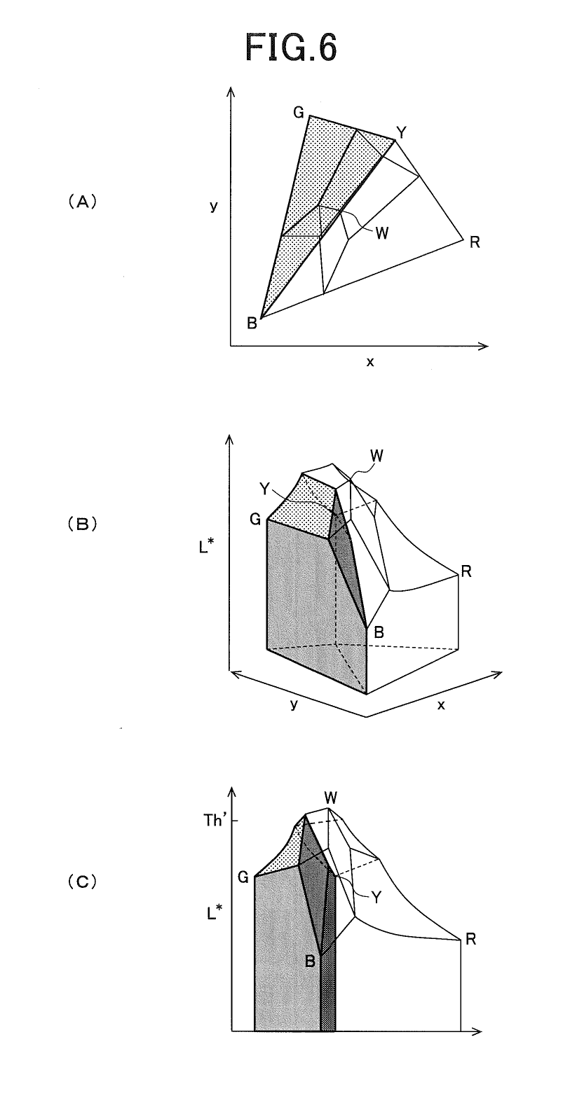

FIG. 4 depicts an example of a color gamut representable by the liquid crystal display device (the liquid crystal display device supporting four-primary-color (RGBY) display). FIG. 4(A) is a top view of a three-dimensional color space diagram and may be called an x-y chromaticity diagram at a lightness L*. FIG. 4(B) is a three-dimensional color space diagram and FIG. 4(C) is a view of FIG. 4(B) from a direction parallel to an x-y plane. FIG. 5 depicts an example of a region having a lightness not more than a predetermined lightness in the color gamut of FIG. 4. FIG. 5(A) is an x-y chromaticity diagram at a lightness L* not more than the predetermined lightness; FIG. 5(B) is a three-dimensional color space diagram; and FIG. 5(C) is a view of FIG. 5(B) from a direction parallel to the x-y plane. FIG. 6 depicts another example of the region having a lightness not more than the predetermined lightness in the color gamut of FIG. 4. FIG. 6(A) is an x-y chromaticity diagram at a lightness L* not more than the predetermined lightness; FIG. 6(B) is a three-dimensional color space diagram; and FIG. 6(C) is a view of FIG. 6(B) from a direction parallel to the x-y plane.

As the main feature of the present invention, when representing a pixel color of a pixel signal in an input video signal, the liquid crystal display device represents at least one pixel color which has a lightness less than a predetermined lightness and which is in areas except on the boundary of the color gamut, using only three of the four primary colors. In other words, at the lightness less than the predetermined lightness, there are disposed chromaticity regions where color representation is made using three primary colors in areas except on the boundary of the color gamut. This provides an effect of improving the viewing angle characteristics at a lightness less than the predetermined lightness, thereby leading to an effect that the display performances can be optimized. Reasons for provision of such effects will hereinafter be described.

The lightness (L*) can be Brightness in the L*a*b colorimetric system (L*a*b color space) or the L*u*v colorimetric system (L*u*v color space), but the lightness may be defined otherwise as long as when white is 100(%), the other colors can be represented as relative values thereof. In the following description, the lightness ranges from 0 to 100 in accordance with the range of the ordinary diffusion colors.

The predetermined lightness is determined depending on the display portion of the liquid crystal display device and, more specifically, is determined depending on a color gamut representable by the liquid crystal display device (i.e., a color gamut representable in four primary colors by the liquid crystal display device). As an extreme example, even when the liquid crystal display device is configured to have a predetermined lightness of 99, the effect of the present invention is ensured that the viewing angle is improved at a lightness less than 99, whereas even if four-primary-color display is performed at only a lightness not less than 99, it is meaningful to extend the color gamut by enabling the liquid crystal display device to perform a four-primary-color display. Thus, the predetermined lightness may be any numerical value other than 100 and, if not 0, the effect of improving the viewing angle is ensured.

Describing the color gamut at a lightness, it refers to a chromaticity region enclosed by a quadrilateral of FIG. 4(A) for example and “on the boundary of the color gamut” refers to “on sides of the quadrilateral” (“on sides of the outer frame”). Describing the color gamut at all the lightnesses, it refers to the interior region of a solid such as a polyhedron depicted in and FIG. 4(B) and FIG. 4(C) (it may be called a curved solid since some edges are curved) and “on the boundary of the color gamut” refers to “on the outer edges (on the outer frame) of the solid”.

Referring next to FIGS. 5 and 6, an example will be given of the predetermined lightness in the color gamut exemplified in FIG. 4.

In the liquid crystal display device supporting four-primary-color (RGBY) display whose color gamut is defined in FIG. 4, pixel color regions representable without lighting the sub-pixels G are regions shown in gray in FIG. 5(A), FIG. 5(B), and FIG. 5(C) for example. If the color gamut is determined, these regions are uniquely determined as regions where the G components can be compensated by other colors such as Y. As depicted in FIG. 5(C), it can be seen that pixel colors representable using only three primary colors R, B, and Y are present among pixel colors having lightness less than a maximum lightness Th in the regions shown in gray.

Similarly, pixel color regions representable without lighting the sub-pixels R are uniquely determined depending on the color gamut and are regions shown in gray in FIG. 6(A), FIG. 6(B), and FIG. 6(C) for example. Determined similar to Th is a threshold value (Th′) of lightness at which one or more pixel colors can be represented using only three primary colors G, B, and Y. In the regions representable without lighting sub-pixels G, Th is the predetermined lightness while in the regions representable without lighting sub-pixels R, Th′ is the predetermined lightness.

This means that the predetermined lightness differs depending on the regions in the color gamut and that in the regions shown in gray in FIGS. 5 and 6, the liquid crystal display device can represent all of pixel colors having lightness less than the predetermined lightness, using only three or less primary colors among the four primary colors.

Thus, in the examples of FIGS. 4 to 6, four primary colors are R, G, B, and Y (i.e., the display portion 6 is an RGBY display) and, as the three primary colors, either a set of G, B, and Y or a set of R, B, and Y is used depending on the chromaticity indicated by a pixel signal in the input video signal. By having a pixel color not displaying the sub-pixel G or R in this manner, the viewing angle characteristics are improved in the areas of the pixel color when representing the pixel color. For example, if the sub-pixels G do not light in a region where the pixel color is orange (yellowish beige), the green float is suppressed when viewed obliquely, leading to an improvement in the viewing angle characteristics of the color (near yellowish beige) of the region. If the sub-pixels R do not light in a region where the pixel color is yellowish green, the red float is suppressed when viewed obliquely, leading to an improvement in the viewing angle characteristics of the yellowing green.

As described above, the liquid crystal display device of the present invention allows pixel colors representable using three primary colors to lie in areas except on the boundary of the color gamut at a lightness less than the predetermined lightness that is determined depending on the color gamut. Naturally, as for pixel colors lying on the boundary of the gamut representable using one to three primary colors, the liquid crystal display device of the present invention can employ any number of and any combinations of primary colors (naturally, four or less primary colors).

Although if at least one color can be represented using only three primary colors, it can be said for the one color that there is an effect of ensuring a best display in viewing characteristics (esp., viewing angle characteristics near yellowish beige), i.e., an effect of achieving an improvement in the viewing angle characteristics, a further effect is expected if more number of colors can be represented using only three primary colors. To attain the further effect, it is preferred at a lightness less than a predetermined lightness to represent pixel colors using three primary colors in all the chromaticity regions except on the boundary of the color gamut. If the four primary colors are R, G, B, and Y as exemplified herein, it is preferred to represent all pixel colors in areas except on the boundary among pixel colors having lightness less than the predetermined lightness using either three colors R, Y, and B or three colors G, Y, and B. More specifically, it is preferred that pixel colors representable without lighting sub-pixels R in the color gamut be all pixel colors in the regions shown in gray in FIG. 6 among pixel colors having lightness less than the lightness Th′. It is also preferred that pixel colors representable without lighting sub-pixels G in the color gamut be all pixel colors in the regions shown in gray in FIG. 5 among pixel colors having lightness less than the lightness Th.

Preferably, the liquid crystal display device of the present invention includes a color conversion processing portion. This color conversion processing portion can be exemplified as the color conversion processing circuit 12 of FIG. 1 and will hereinafter be described as the color conversion processing circuit 12.

If this liquid crystal display device is a device performing a display based on gradation data in which the display luminance becomes lower as the gradation value decreases, the color conversion processing circuit 12 converts components of pixel signals (signals R, G, and B in this example; corresponding to Ri, Gi, and Bi) in an input video signal into a combination of gradation values in which a sum is minimized of gradation values (corresponding Ro, Go, and Bo) for the output to sub-pixels corresponding respectively to the four primary colors (R, G, B, and Y in this example).

This conversion is similarly applicable irrespective of whether the liquid crystal is normally black or normally white since a reduction in the sum of the gradation values results in a reduction in the number of primary colors as long as the liquid crystal display device is a device whose display portion performs a display based on the gradation data in which the display luminance becomes lower as the gradation value decreases.

On the contrary, if this liquid crystal display device is a device performing a display based on gradation data in which the display luminance becomes higher as the gradation value decreases, the color conversion processing circuit 12 converts components of pixel signals in an input video signal into a combination of gradation values in which the sum is maximized. This conversion is similarly applicable irrespective of whether the liquid crystal is normally black or normally white since an increase in the sum of the gradation values results in a reduction in the number of primary colors as long as the liquid crystal display device is a device whose display portion performs a display based on the gradation data in which the display luminance becomes higher as the gradation value decreases.

Although in FIGS. 4 to 6, an example is given where four primary colors are R, G, B, and Y and pixel colors are represented using as the three primary colors either a set of G, B, and Y or a set of R, B, and Y depending on the chromaticity indicated by pixel signals (i.e., depending on the pixel colors of the pixel signals) in the input video signal, the set of primary colors is not limited thereto.

For example, if four primary colors are R, G, B, and W, used as the three primary colors is a set of R, G, and W, or a set of G, B, and W, or a set of B, R, and W depending on the chromaticity indicated by pixel signals in the input video signal. That is, in the case of a display having the display portion 6 of RGBW, pixel colors represented using any three colors among RGW, GBW, and BRW at a lightness less than the predetermined lightness are disposed in areas except on the boundary.

By preparing pixel colors not displaying any sub-pixel among R, G, and B in this manner, the viewing angle characteristics are improved in areas of the pixel colors when representing the pixel colors. More specifically, if the four primary colors are R, G, B, and W, the viewing angle characteristics near cyan are improved by not lighting the sub-pixels R; the viewing angle characteristics near magenta are improved by not lighting the sub-pixels G; and the viewing angle characteristics from orange through yellow to yellowish green near cyan are improved by not lighting the sub-pixels B.

In a non-light-emitting display device supporting RGBW four-primary-color display such as the liquid crystal display device exemplified herein, if the lightness is less than the predetermined lightness, a set of R, G, and B may be employed as the three primary colors when representing pixel colors. By having a pixel color not displaying the sub-pixel W, the viewing angle characteristics are improved in areas of the pixel color when representing the pixel color. For example, in a region whose pixel color is pink, a region whose pixel color is light green, and a region whose pixel color is cyan, white float is suppressed when viewed obliquely by not lighting the sub-pixels W, contributing to an improvement in the viewing angle characteristics. To supplement the above, in the case of a light-emitting display device described later, a power saving effect is achieved, but when displaying with only RGB, the luminance becomes insufficient since W is normally a pixel having a high luminance and hence such the effect is not achieved. Accordingly, in the case of a light-emitting display device supporting RGBW four-primary-color display, representing using the three primary colors RGB is out of selection.

If the four primary colors are R, G, B, and C, a set of G, C, and R or a set of B, C, and R is used as the three primary colors depending on the chromaticity indicated by the pixel signals in the input video signal. That is, in the case of a display having the RGBC display portion 6, pixel colors represented using three colors GCR or BCR at a lightness less than the predetermined lightness are disposed in areas except on the boundary.

By preparing pixel colors not displaying the sub-pixels B or G in this manner, the viewing angle characteristics are improved in areas of the pixel colors when representing the pixel colors. More specifically, if the four primary colors are R, G, B, and C, the viewing angle characteristics near magenta are improved by not lighting the sub-pixels G; and the viewing angle characteristics near orange are improved by not lighting the sub-pixels B.

Details of a conversion method in the color conversion processing circuit 12 will then be described.

The color conversion processing circuit 12 executes the above conversions, with the result that in areas except the boundary of the color gamut there become present pixel colors representable using only three primary colors at a lightness less than the predetermined lightness while also on the boundary of the color gamut there become present pixel colors representable using only not more than two primary colors as small as possible in number. In other words, the color conversion processing circuit 12 converts each of components of a pixel signal using a conversion equation irrespective of the lightness and, if the color is not representable by not more than three primary colors, obtains a conversion result of representing the color by all of four primary colors.

This conversion equation will be described. Adopting a linear programming, there is obtained an optimum combination of primary colors under certain restriction conditions. The liner programming is a method for finding a value maximizing or minimizing a linear expression (objective function) among values of variables satisfying some linear inequalities and linear equalities. According to the linear programming, tristimulus values (Xₜ, Yₜ, Zₜ) of a color can be expressed by the following equation in an RGBE display. E refers to a primary color (fourth primary color) other than RGB among the four primary colors.

$$[ \begin{matrix}{X}_{t} \\ {Y}_{t} \\ {Z}_{t}\end{matrix} ] = [ \begin{matrix}{X}_{r} & {X}_{g} & {X}_{b} & {X}_{e} \\ {Y}_{r} & {Y}_{g} & {Y}_{b} & {Y}_{e} \\ {Z}_{r} & {Z}_{g} & {Z}_{b} & {Z}_{e}\end{matrix} ] [ \begin{matrix}r \\ g \\ b \\ e\end{matrix} ] \qquad [ Eq . 1 ]$$

The matrix in the above equation is a matrix expressing the color gamut of the display portion 6 and is composed of coefficients corresponding to the primary colors in the display portion 6. In the case of the liquid crystal display device as in this example, the matrix is mainly composed of coefficients corresponding to colors of a color filter. Xᵣ, Yᵣ, and Zᵣ denote tristimulus values of the primary color R; X_{g}, y_{g}, and Z_{g} denote tristimulus values of the primary color G; X_{b}, Y_{b}, and Z_{b} denote tristimulus values of the primary color B; and Xₑ, Yₑ, and Zₑ denote tristimulus values of the primary color E. r, g, b, and e denote the lighting rate of sub-pixels of red, green, blue, and the fourth primary color, respectively. Since the tristimulus values (Xₜ, Yₜ, Zₜ) of a color can be obtained through conversion from R, G, and B, an input to the color conversion processing circuit 12 may be either tristimulus-value XYZ signals or RGB signals.

The above equation is expanded as follows:

Xₜ=rXᵣ+gX_{g}+bX+eXₑ

Yₜ=rYᵣ+gY_{g}+bY+eY,

Zₜ=rZᵣ+gZ_{g}+bZ+eZₑ

Xᵣ+X_{g}+X_{b}+Xₑ is a tristimulus value X of white and (Xₜ, Yₜ, Zₜ) obtained as a result of multiplying this by the lighting rate (r, g, b, e) of each sub-pixel expresses tristimulus values of a display color.

In the above equation, there are three equalities and four unknowns and hence there exist innumerable combinations (r, g, b, e) of primary colors representing a color (Xₜ, Yₜ, Zₜ). Thus, the objective function F is set as a following equation to find r, g, b, and e minimizing F(r, g, b, e) from numerical value calculations based on the linear programming.

F(r,g,b,e)=r+g+b+e

The set (r, g, b, e) of the lighting rate minimizing F(r, g, b, e) is found for each of all pixel colors (in other words, all colors representable as (Xₜ, Yₜ, Zₜ)) included in the color gamut of the liquid crystal display device. Here description is made of the case where the liquid crystal display device is a device performing a display based on the gradation data in which the display luminance becomes lower as the gradation value decreases. As is described here, if the lighting rate becomes larger as the gradation value increases, it can be said that the set (r, g, b, e) of the lighting rate is synonymous with the set of the gradation values. Thus, F(r, g, b, e) is equivalent to the above sum (the sum of the gradation values for the output to sub-pixels).

As an example of the calculation results, on finding a combination minimizing the sum of a gradation value (r) of R, a gradation value (g) of G, a gradation value (b) of B, and a gradation value (y) of Y in the display device supporting RGBY four-primary-color display, G does not light in the lighting regions of R at a lightness less than a predetermined lightness and R does not light in the lighting region of G at a lightness less than a predetermined lightness (another predetermined lightness; but both may be of the same value). The converse is also true; if G does not light in the lighting regions of R at a lightness less than a predetermined lightness and R does not light in the lighting region of G at a lightness less than a predetermined lightness, F(r, g, b, e) become minimum.

Similarly, if this liquid crystal display device is a device performing a display based on the gradation data in which the display luminance becomes higher as the gradation value decreases, r, g, b, and e maximizing F(r, g, b, e) are found from numerical value calculations based on the linear programming. As an example of the calculation results, on describing the case of the display device supporting RGBY four-primary-color display, F(r, g, b, e) becomes maximum if G does not light in the lighting regions of R at a lightness less than a predetermined lightness and R does not light in the lighting regions of G at a lightness less than another predetermined lightness.

The predetermined lightness will be described supplementarily. In the case of the device performing a display based on the gradation data in which the display luminance becomes lower as the gradation value decreases, a set of gradation values minimizing the sum (i.e., F) is found for each of all pixel colors included in the color gamut of the liquid crystal display device, with the result that the limit value of lightness representable using only three colors is uniquely determined for each chromaticity. Similarly, in the case of the device performing a display based on the gradation data in which the display luminance becomes higher as the gradation value decreases, a set of gradation values maximizing the sum (i.e., F) is found for each of all pixel colors included in the color gamut of the liquid crystal display device, with the result that the limit value of lightness representable using only three colors is uniquely determined for each chromaticity.

Therefore, in this example, the main feature (hereinafter referred to as first feature) of the present invention of disposing (except on the boundary) at least one pixel color represented using only three primary colors at a lightness less than a predetermined lightness is implemented by a second feature of providing the display device with the color conversion processing circuit 12 that performs such conversion for all the lightnesses. Naturally, the present invention may be configured as invention having the second feature instead of the first feature.

Furthermore, in this example, the first feature is implemented by a third feature that follows. The third feature is a feature of, when representing a color having a chromaticity, using only three primary colors among four primary colors at a lightness less than a predetermined lightness (the limit value uniquely determined if the color gamut of the display portion 6 is determined) defined for each chromaticity. It is natural that the present invention may be configured as invention having the third feature instead of the first feature. On describing by way of example of FIG. 5(B), the predetermined lightness for each chromaticity when defining in this manner is expressed by upper three curved surfaces, i.e., by areas of outer walls except vertically extending two side walls among outer walls shown in gray. Although colors below the three curved surfaces can be represented by either three colors or four colors, they are represented by three colors in the present invention.

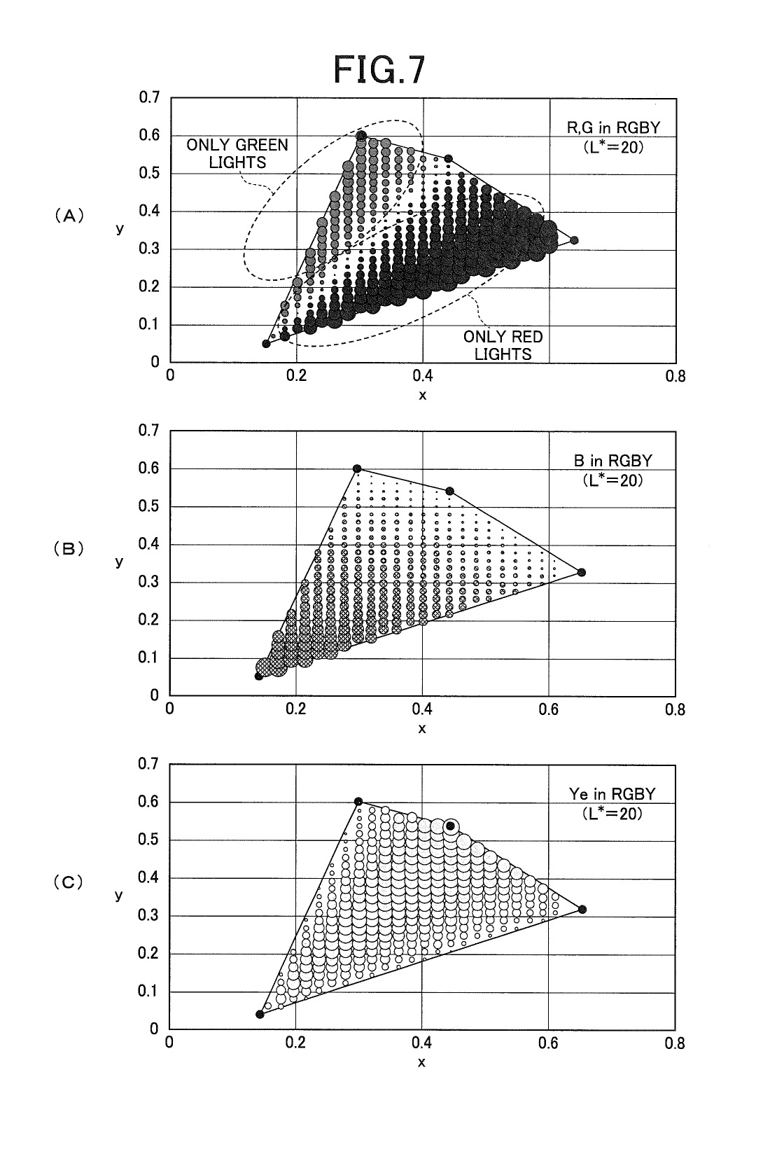

Referring to FIGS. 7 to 12, description will be given of the lighting rate calculated by the linear programming as described above.

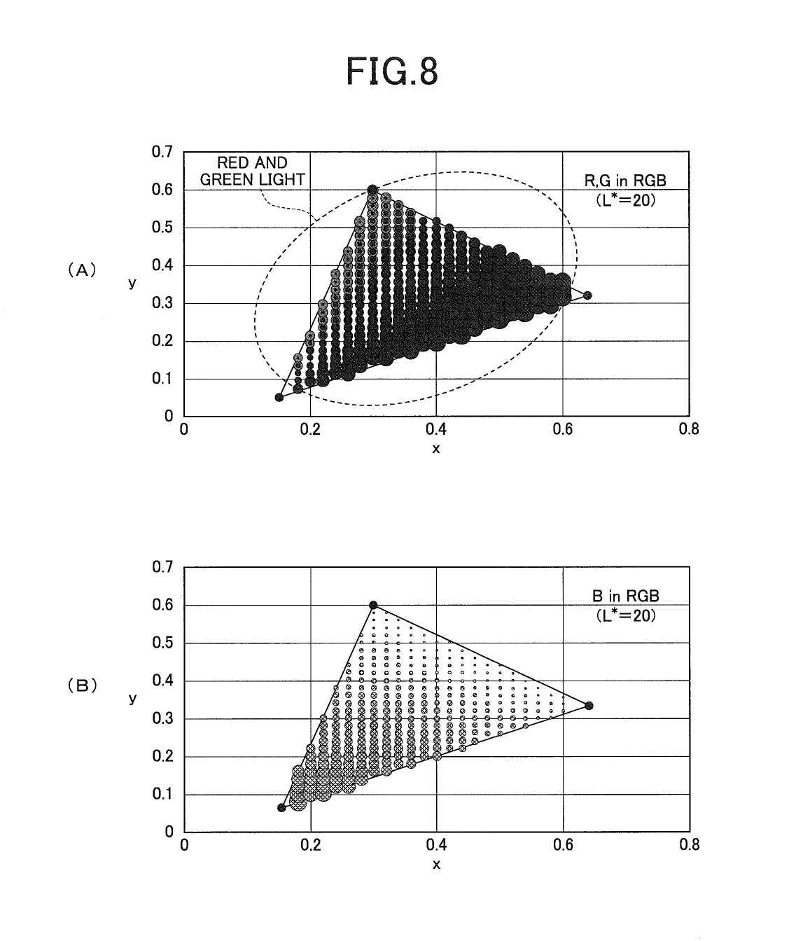

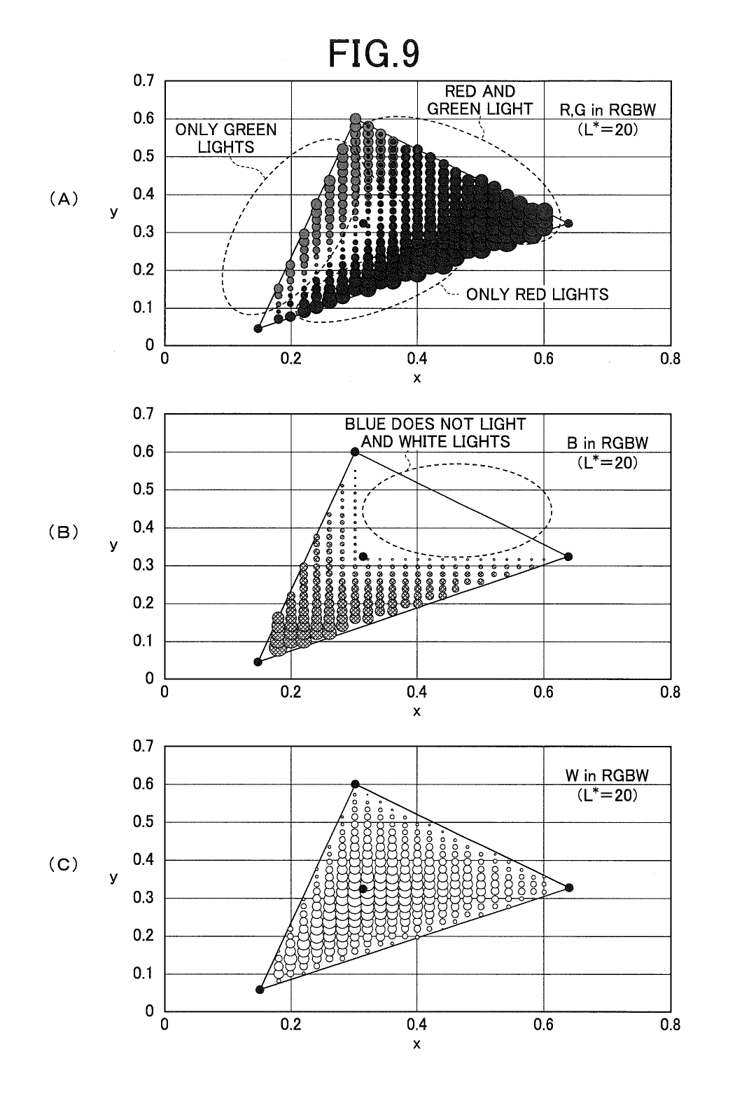

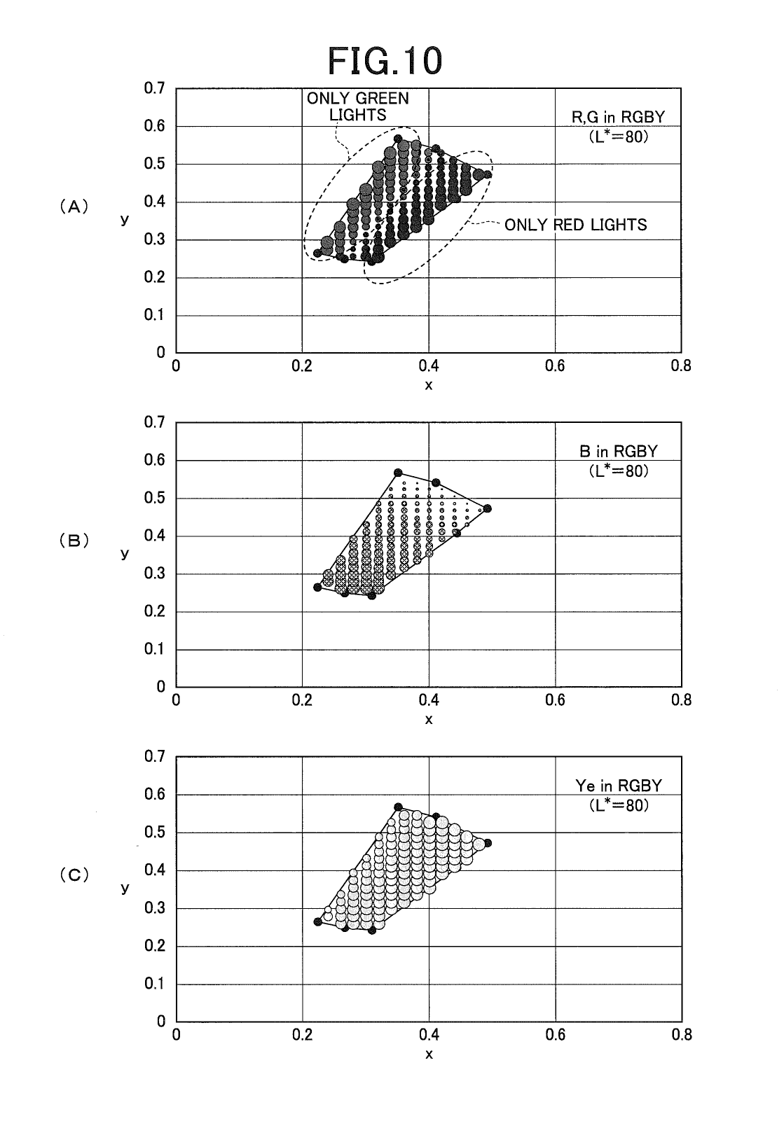

FIG. 7 is a diagram depicting an example of the lighting rate of each of primary colors at L*=20 in a liquid crystal display device supporting four-primary-color (RGBY) display according to the present invention; and FIG. 8 is a diagram depicting an example of the lighting rate of each of primary colors at L*=20 in the conventional liquid crystal display device supporting three-primary-color (RGB) display. FIG. 9 is a diagram depicting an example of the lighting rate of each of primary colors at L*=20 in a liquid crystal display device supporting four-primary-color (RGBW) display according to the present invention. FIGS. 10, 11, and 12 correspond respectively to FIGS. 7, 8, and 9, depicting an example of the lighting rate of each of primary colors at L*=80.

In FIGS. 7 to 12, for a chromaticity in the color gamut, the level of the lighting rate of each primary color is indicated by the size of a circle at the position of the chromaticity. That is, it is shown here that according as the circle indicated at the position of the chromaticity is larger the lighting rate of the primary color is higher at the chromaticity.

As indicating the lighting rates of R and G among four primary colors (RGBY) in FIG. 7(A), in this case, the color gamut is separated into two regions, i.e., a region where only R lights and a region where only G lights. As depicted in FIG. 7(B) and FIG. 7(C), respectively, the lighting rates of B and Y among the four primary colors are not zero throughout the entire color gamut (except on the boundary).

Accordingly, in the liquid crystal display device supporting four-primary-color RGBY display exemplified here, in at least the case of L′=20, the color representation is possible using only three primary colors RBY or GBY and, since R and G do not light at the same time, best viewing angle characteristics are achieved. Reversely, in the case where the optimization is not performed as in the conventional art, the R-lighting regions overlap with the G-lighting regions throughout the overall area although not shown, and therefore green floats appear when viewed obliquely near yellowish beige for example throughout the overall area.

For the comparison, the display device supporting three-primary-color (RGB) display will be described. As indicating the lighting rates of R and G among three primary colors (RGB) in FIG. 8(A), for all the chromaticities in the color gamut, both R and G light. In FIG. 8(A), however, on its right side in particular there exist areas the lighting rate of G is hidden by the lighting rate of R. The lighting rate of B among the three primary colors is also not 0 (except on the boundary) throughout the entire color gamut as depicted in FIG. 8(B). In this manner, in the conventional display device supporting three-primary-color (RGB) display, R, G, and B light in the entire regions and, in this case as well, since the R-lighting regions and the G-lighting regions overlap in the entire area, green floats appear when viewed obliquely near yellowish beige for example in the entire area.

As indicating the lighting rates of R and G among four primary colors (RGBW) in FIG. 9(A), the color gamut in this case is separated into three regions, i.e., a region where only R lights, a region where only G lights, and a region where both R and G light. As depicted in FIG. 9(B), the lighting rate of B among four primary colors is 0 in a region and this region is coincident with the region where both R and G light. As depicted in FIG. 9(C), respectively, the lighting rate of W in four primary colors is not 0 throughout the overall color gamut (except on the boundary).

Accordingly, in the liquid crystal display device supporting four-primary-color RGBW display, the color representation is possible using only any three primary colors among RGW, GBW, and BRW at least at L*=20. Although giving an example where the both R and G lighting region and the B lighting region do not overlap at all, they may partly overlap and, in that case, only the overlapping chromaticity regions have the four-primary-color representation. On the contrary, in the case of not performing the optimization as in the prior art, the R lighting region and the G lighting region for example overlap in the entire area although not shown and hence green floats appear when viewed obliquely near yellowish beige.

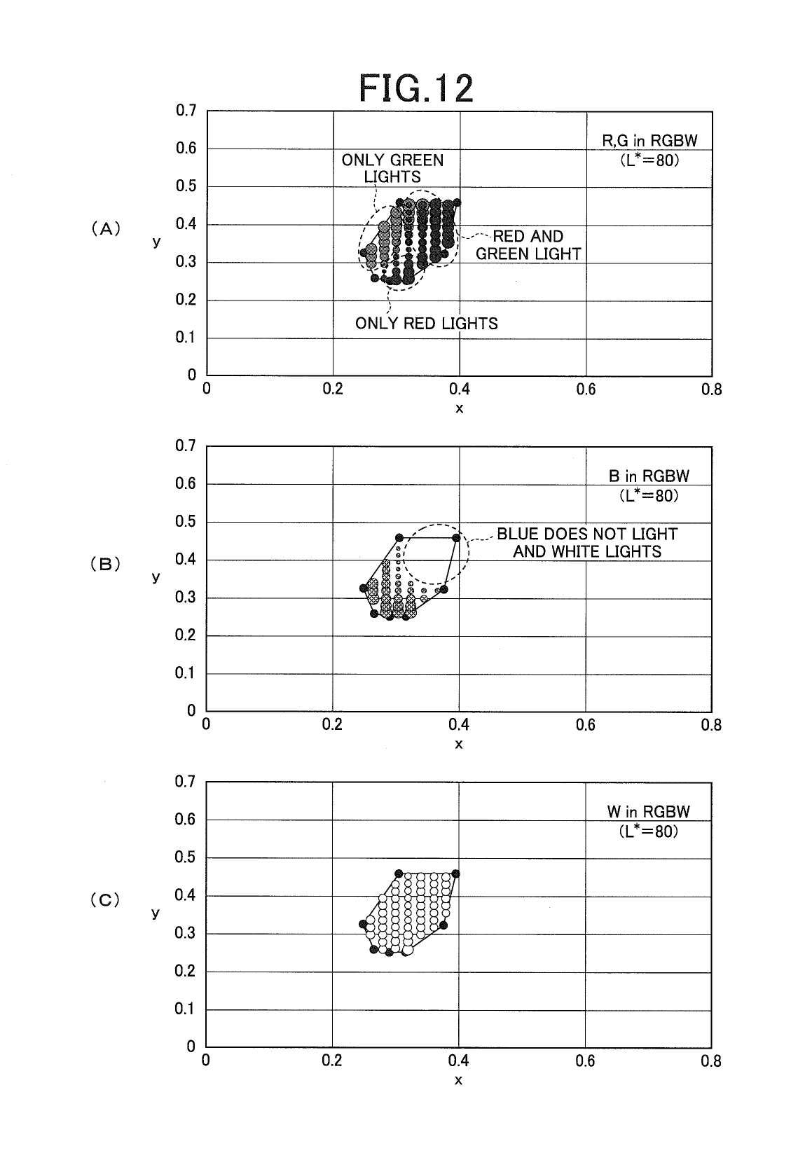

In the case of L*=80 as depicted in FIGS. 10 to 12, basically the same tendency is seen although the color gamut becomes smaller than the case of L*=20. In the case of L*=80, however, as depicted in FIG. 10(A) and FIG. 12(A), there occur some regions where both R and G light in the four-primary-color display of both RGBY and RGBW.

As can be seen from the comparison between the case of L*=20 and the case of L*=80, according as the lightness rises the chromaticity region to be represented using all of the four primary colors increases whereas the chromaticity representable using three primary colors decreases. It can be said that the predetermined lightness is a lightness at a point of time when the chromaticity representable using three primary colors goes absent as a result of further increasing the lightness.

Description will then be given of a configuration for easily implementing the above conversion method in the color conversion processing circuit 12. It is not preferred from the viewpoint of speed to execute the above conversion in the color conversion processing circuit 12 by calculations for each pixel. Thus, the color conversion processing circuit 12 preferably has a three-dimensional look-up table (3D-LUT) for converting components of the pixel signals in the input video signal into gradation values for the output to sub-pixels corresponding to the four primary colors, respectively.

The 3D-LUT is calculated in advance and created in such a manner that the sets of pixel colors (Xₜ, Yₜ, Zₜ) and the sets of (r, g, b, e) as the conversion results thereof are correlated with each other. The 3D-LUT has many adjusting points and hence use of the 3D-LUT enables accurate adjustments.

If the liquid crystal display device is a device performing a display based on gradation data in which the display luminance becomes lower as the gradation value decreases, the conversion is performed for pixel values using only the three primary colors in such a manner as to minimize (generally to 0) the gradation value to a sub-pixel of one color not used among gradation values to four sub-pixels. On the contrary, if the liquid crystal display device is a device performing a display based on gradation data in which the display luminance becomes higher as the gradation value decreases, the conversion is performed for pixel values using only the three primary colors in such a manner as to maximize (to 255 in the case of 8-bit data) the gradation value to a sub-pixel of one color not used among gradation values to four sub-pixels. Accordingly, such a value is prepared in the 3D-LUT as the gradation value after conversion for a sub-pixel of one color not used.

The color conversion processing circuit 12 does not necessarily have to have the 3D-LUT and it may not have the LUT itself if the calculation speed is neglected as in the above. The LUT may be an LUT for each component, instead of the 3D-LUT. The LUT for each component is referred to when representing a specific color and conversion is made so as to obtain the target color using the gradation value of each component fetched from a corresponding LUT. For example, if the input pixel signals are R, G, and B signals, gradation values of R and Y components are fetched from an LUT for R; gradation values of G and Y components are fetched from an LUT for G; and gradation values of B and Y components are fetched from an LUT for B, with the gradation value of Y being obtained from e.g., totaling-up for the conversion.

Although an example of having the color conversion processing circuit 12 was given, examples of not providing the liquid crystal display device with the color conversion processing circuit can be forms, e.g., a form of disposing the same color conversion processing circuit on a source device such as a recorder or a player such that the source device enters a converted signal directly into the display device and a form of externally inputting a signal (the same signal as the converted signal) suitable for the display on the display device of the present invention.

In the configuration example of FIG. 1, description was given by way of the example where RGB signals are input as pixel signals in an input video signal into the color conversion processing circuit 12 and by way of the example where RGB signals or tristimulus value XYZ signals are input in the above conversion equation. The signals input to the color conversion processing circuit 12 may be signals of other combinations such as signals of four colors including RGB since similar concept applies to the conversion although the conversion equations differs. Here, the signals of four colors including RGB are signals before the optimization and may be signals for four colors different in combination from the four primary colors. For example, RGBY signals may be input as pixel signals of an input video signal into the liquid crystal display device supporting four-primary-color RGBW display and may be converted into RGBW signals for display.

Describing it using the above conversion equation, when a four-color signal (denoted as (rr, gg, bb, ee)) is input, a color (Xₜ, Yₜ, Zₜ) represented thereby is uniquely determined, but there are a plurality of other combinations of primary colors that can represent (Xₜ, Yₜ, Zₜ) and hence an optimum combination (r, g, b, e) needs to be selected from thereamong. That is, in the device configured to convert the input four-color signal (rr, gg, bb, ee) into an optimum four-primary-color signal (r, g, b, e), as a result, the conversion is performed through the same conversion processes as the processes of converting the set of (rr, gg, bb, ee) into a set of (Xₜ, Yₜ, Zₜ) in accordance with a predetermined matrix coefficient and thereafter converting it into a set of (r, g, b, e) using the above conversion equation. Thus, in the same manner, conversion is performed to (r, g, b, e) minimizing (or maximizing) F for (Xₜ, Yₜ, Zₜ). In other words, conversion is performed to (r, g, b, e) minimizing (or maximizing) F for (Xₜ, Yₜ, Zₜ) corresponding to the sets of (rr, gg, bb, ee). In practice, a conversion result minimizing (or maximizing) F is found in advance and conversion is performed referring to the 3D-LUT in the form of a table in which the sets of (rr, gg, bb, ee) are correlated with (r, g, b, e) as the conversion result.

In the above description, assumption is such that the area ratio (aperture ratio) of a sub-pixel of each primary color is the same, but the display portion may use a different aperture ratio for each of the primary colors. In the case of disposing a plurality of sub-pixels for a color in one pixel, the aperture ratio of the primary color refers to the total aperture ratio of the plurality of sub-pixels. Even in such a case, however, the color conversion processing circuit 12 converts components of pixel signals in an input video signal into combinations of gradation values in a similar manner. For example, in the case of using the above conversion equation, even if the aperture ratio of a sub-pixel differs depending on the primary color, a process such as weighting (r, g, b, e) in particular need not be performed since the tristimulus values of a primary color vary accordingly.

Although the display device of the present invention has been described by way of example of a liquid crystal display device, this is not limitative and the present invention may be applied similarly to a display device having another non-light-emitting display panel in lieu of the liquid crystal panel. In that case as well, the same effect is ensured.

The display device of the present invention may be a device having as the display portion 6 of FIG. 1 a light-emitting display panel such as an organic EL (Electro-Luminescence) display panel or a PDP (Plasma Display Panel), on which display panel there appears video indicated by an input video signal. In the case of the organic EL display panel, the four-primary-color display becomes possible by e.g., a system of using four-color light-emitting layers or a system of using four-color color filters. In the PDP, the four-primary-color display becomes possible by e.g., providing fluorescent members of four different colors.

Similar to the non-light-emitting display device such as the liquid crystal display device, the light-emitting display device has an effect of achieving optimization in the display performances through the combinations of primary colors but differs therefrom in that the power consumption is optimized. For example, at a lightness less than a predetermined lightness, G does not light in the R lighting region and R does not light in the G lighting region, whereupon the presence of inactive sub-pixels leads to power saving, achieving a reduction in power consumption. In other words, the power saving is achieved by applying at least one of the first feature, the second feature, and the third feature that are main features of the present invention to the display device having the light-emitting display panel.

Regarding the optimization in combination of primary colors, the relationship with the gradation data will be described supplementarily. If the light-emitting display device is a device performing a display based on gradation data in which the display luminance becomes lower as the gradation value decreases, the color conversion processing portion exemplified by the color conversion processing circuit 12 converts components of pixel signals in an input video signal into combinations of gradation values minimizing the sum of the gradation values for the output to the sub-pixels corresponding to the four primary colors, respectively. This reason is that the light-emitting display portion consumes more power according as the emission luminance rises and that according as the total of the gradation values of four colors decreases the emission luminance falls, leading to power saving. In this example, describing it using the above conversion equation, the power consumption is minimized when F(r, g, b, e) becomes minimum.

On the other hand, if the light-emitting display device is a device performing a display based on gradation data in which the display luminance becomes higher as the gradation value decreases, the color conversion processing portion exemplified by the color conversion processing circuit 12 converts the components into combinations of gradation values maximizing the sum. This reason is that as described above the light-emitting display portion consumes more power according as the emission luminance rises and that according as the total of the gradation values of four colors increases the emission luminance falls, leading to power saving. In this example, describing it using the above conversion equation, the power consumption is minimized when F(r, g, b, e) becomes maximum.

Regarding the others, the description for the liquid crystal display device applies basically to the light-emitting display device and hence description thereof will be omitted.

The display device may be a projection display device including a non-light-emitting display panel such as a liquid crystal panel; a backlight (irradiation lamp) irradiating the back of the display panel; a transmissive screen; and a projection lens projecting video displayed on the display panel onto the rear of the screen. The projection display device having such a configuration is a device projecting video onto the rear of the screen disposed inside the device, to thereby view transmitted light and is called a rear projector. By virtue of having the non-light-emitting display panel, this rear projector can improve the viewing angle characteristics as described by way of example of the liquid crystal display device. Regarding the others, the description for the liquid crystal display device applies basically to the display device in the form of the rear projector and hence description thereof will be omitted.

As described above, in the display device supporting four-primary-color display, there exist a plurality of combinations of primary colors representing a color but differences occur in power consumption and in viewing angle characteristics depending on the combination of primary colors and hence an optimum combination is selected so that the display performances can be improved. Here, according to the light-emitting display device of the present invention, the combination of four primary colors can be optimized so as to reduce the power consumption; and by using a similar combination, according to the non-light-emitting display device of the present invention, the optimization can be performed so as to improve the viewing angle characteristics. In contrast with this, the conventional techniques do not give consideration to the optimization in the display performances and do not perform a display using only three primary colors in the display device supporting four-primary-color display, and hence the present invention can be said to be beneficial.

### EXPLANATIONS OF LETTERS OR NUMERALS

1 . . . drive control circuit, 2 . . . input portion, 3 . . . video processing circuit, 4 . . . . control portion, 5 . . . light source control circuit, 6 . . . display portion, 7 . . . color filter, 8 . . . liquid crystal panel body, 9 . . . backlight light source, 11 . . . display control circuit, 12 . . . color conversion processing circuit, 13 . . . data signal line driving circuit, 14 . . . scanning signal line driving circuit, 61 . . . sub-pixel forming portion, 61a . . . TFT, 61b . . . pixel electrode, 61c . . . auxiliary electrode, and 62 . . . pixel forming portion.

1.-11. (canceled)

12. A display device displaying video indicated by an input video signal using pixels composed of four primary colors and each having at least one sub-pixel for one primary color, wherein
when representing pixel colors of pixel signals in the input video signal, at least one pixel color which has a lightness less than a predetermined lightness determined depending on a color gamut representable by the display device and which is in areas except on a boundary of the color gamut is represented using only three primary colors among the four primary colors.

13. The display device as defined in claim 12, wherein
the display device is a device performing a display based on gradation data in which a display luminance becomes lower as a gradation value decreases, and the display device comprises:
a color conversion processing portion that converts components of the pixel signals in the input video signal into combinations of gradation values minimizing a sum of the gradation values for output to sub-pixels corresponding respectively to the four primary colors.

14. The display device as defined in claim 12, wherein
the display device is a device performing a display based on gradation data in which a display luminance becomes higher as a gradation value decreases, and the display device comprises:
a color conversion processing portion that converts components of the pixel signals in the input video signal into combinations of gradation values maximizing a sum of the gradation values for output to sub-pixels corresponding respectively to the four primary colors.

15. The display device as defined in claim 13, wherein
the color conversion processing portion has a three-dimensional look-up table for converting the components of the pixel signals in the input video signal into gradation values for output to sub-pixels corresponding respectively to the four primary colors.

16. The display device as defined in claim 14, wherein
the color conversion processing portion has a three-dimensional look-up table for converting the components of the pixel signals in the input video signal into gradation values for output to sub-pixels corresponding respectively to the four primary colors.

17. The display device as defined in claim 13, wherein
any one of RGB signals, tristimulus value XYZ signals, and signals of four colors including RGB are input as the pixel signals in the input video signal into the color conversion processing portion.

18. The display device as defined in claim 14, wherein
any one of RGB signals, tristimulus value XYZ signals, and signals of four colors including RGB are input as the pixel signals in the input video signal into the color conversion processing portion.

19. The display device as defined in claim 12, wherein
the four primary colors are red, green, blue, and yellow, and wherein
either a set of red, yellow, and blue or a set of green, yellow, and blue is used as the three primary colors depending on chromaticity indicated by the pixel signals in the input video signal.

20. The display device as defined in claim 12, wherein
the four primary colors are red, green, blue, and white, and wherein
a set of red, green, and white or a set of green, blue, and white or a set of blue, red, and white is used as the three primary colors depending on chromaticity indicated by the pixel signals in the input video signal.

21. The display device as defined in claim 12, wherein
the four primary colors are red, green, blue, and cyan, and wherein
either a set of green, cyan, and red or a set of blue, cyan, and red is used as the three primary colors depending on chromaticity indicated by the pixel signals in the input video signal.

22. The display device as defined in claim 12, comprising:
a non-light-emitting display panel; and
a backlight irradiating a back of the display panel, wherein
video indicated by the input video signal is displayed on the display panel.

23. The display device as defined in claim 12, comprising:
a light-emitting display panel, wherein
video indicated by the input video signal is displayed on the display panel.

24. The display device as defined in claim 12, wherein
the display device is a projection display device comprising:
a non-light-emitting display panel displaying video indicated by the input video signal;
a backlight irradiating a back of the display panel;
a transmissive screen; and
a projection lens projecting video displayed on the display panel onto a rear of the screen.

25. A display method for displaying video indicated by an input video signal using pixels composed of four primary colors and each having at least one sub-pixel for one primary color in a display device, wherein
when representing pixel colors of pixel signals in the input video signal, at least one pixel color which has a lightness less than a predetermined lightness determined depending on a color gamut representable by the display device and which is in areas except on a boundary of the color gamut is represented using only three primary colors among the four primary colors.
